(19) United States
(12) Patent Application Publication
(10) Pub. No.: US 2018/0070627 A1
(43) Pub. Date: Mar. 15, 2018

(54) Improvements in methods of treating tobacco

(71) Applicant: British American Tobacco (Investments) Limited, London (GB)

(72) Inventors: Andrew BURTON, London (GB); Stephen COATES, London (GB); Nicholas ROSSER, London (GB)

(21) Appl. No.: 15/559,170

(22) PCT Filed: Mar. 17, 2016
(86) PCT No.: PCT/GB2016/050733

§ 371 Date: Sep. 18, 2017

(30) Foreign Application Priority Data
Mar. 18, 2015 (GB) 1504587.5

(51) Int. Cl. A24B 15/24; A24B 15/22; B01D 15/36

(52) U.S. Cl. CPC A24B 15/245; B01D 15/361; A24B 15/22

(57) ABSTRACT

The invention relates to method of treating a material containing nicotine and at least one nitrosamine to reduce the quantity of nitrosamine therein and to methods of producing a tobacco extract with reduced nitrosamine content. The methods comprise contacting tobacco with a solvent to produce a liquid phase tobacco extract containing nitrosamines and treating the liquid phase tobacco extract to decompose the nitrosamines in the liquid phase. The liquid phase extract may then be treated to reduce nitrosamine decomposition products therein. The invention also relates to tobacco material produced using these methods and to tobacco products incorporating such tobacco material.

### FIELD

This invention relates to methods of treating tobacco and to methods of producing tobacco extracts, tobacco material, tobacco products and other nicotine-delivery products, and to methods of reducing the nitrosamine content of materials.

### BACKGROUND

A variety of nicotine-delivery products is now available to consumers, including: combustible tobacco products, such as cigarettes, cigars and cigarillos, in which nicotine and other materials are driven from the tobacco as a result of combustion in the form of smoke; non-combustible heated tobacco products, in which nicotine is driven from the tobacco in the form of an aerosol or vapour, without combustion of the tobacco; oral products such as snus, hard tobacco, chewing tobacco and chewing gums containing nicotine; aerosol or volatilisation products such as electronic cigarettes in which a nicotine-containing vapour or aerosol is generated from a liquid source and inhaled by the consumer; and transdermal products such as adhesive patches from which nicotine is delivered from a dermatologically suitable matrix in the patch to the consumer through the skin.

A variety of nicotine-containing materials may be used in the manufacture of nicotine-delivery products, including: tobacco plant material; reconditioned tobacco material, usually in the form of a sheet cast from a suspension of tobacco particles in a liquid carrier; tobacco substitutes, being material not derived, or only partially derived, from tobacco plant material but having similar properties thereto and capable of combustion to deliver smoke containing nicotine; tobacco extract, based upon the liquid phase of a solvent extraction of tobacco material; encapsulated materials; liquid tobacco, being a liquid phase suspension or solution of tobacco; aerosol generating or volatilisable materials, which may for example contain nicotine together with a carrier, flavourants and water.

Cured tobacco naturally contains nicotine together with undesirable nitrosamine compounds, in particular the compounds known as tobacco specific nitrosamines (TSNAs), some examples of which are as follows:

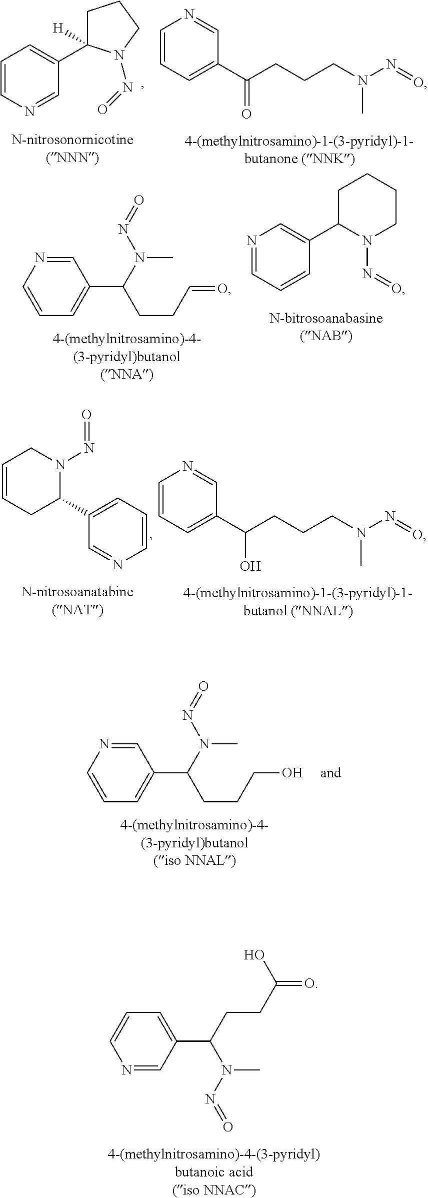

In the manufacture of nicotine-containing materials for incorporation in nicotine delivery products, it is desirable to reduce the content of nitrosamine compounds.

### SUMMARY

This specification discloses methods of treating materials containing nicotine and at least one nitrosamine to reduce the quantity of nitrosamine therein. In one embodiment, the method comprises exposing material containing nicotine and a nitrosamine to electromagnetic radiation of a wavelength that causes the nitrosamine in the material to decompose; wherein the material is exposed to the electromagnetic radiation at a rate of at least 1500 Joules/litre.

In another embodiment, the method comprises exposing the material to electromagnetic radiation in of a wavelength that causes nitrosamines in the material to decompose; and further treating the material to reduce nitrosamine decomposition products therein after exposing the tobacco extract to the electromagnetic radiation.

The material containing nicotine and a nitrosamine may be in any of the forms used in nicotine delivery products, for example tobacco material, reconditioned tobacco material, a tobacco substitute, liquid tobacco extract, an encapsulated material, liquid tobacco, an aerosol-generating or volatilisable material, a solid or liquid matrix or carrier, for example liquids, gels, pastes, creams, powders.

In one embodiment, the material containing nicotine and at least one nitrosamine comprises a liquid phase tobacco extract produced by contacting tobacco with a solvent.

In accordance with this embodiment, the method of treating the material comprises contacting tobacco with a solvent to produce a liquid phase tobacco extract material that contains at least one nitrosamine and a solid phase material comprising extracted tobacco; treating the liquid phase tobacco extract material to decompose nitrosamines therein; and treating the liquid phase tobacco extract material to reduce the amount of nitrosamine decomposition products therein.

This specification also discloses methods of producing a tobacco extract and methods of producing tobacco material.

In one embodiment, a method of producing a tobacco extract comprises contacting tobacco with a solvent to produce a liquid phase tobacco extract containing nitrosamines and a solid phase comprising extracted tobacco; treating the liquid phase tobacco extract to decompose nitrosamines therein; and treating the liquid phase tobacco extract to reduce nitrosamine decomposition products therein.

Nitrosamines typically may decompose to form nitrates and or nitrites. Accordingly, in another embodiment, a method of producing a tobacco extract comprises contacting tobacco with a solvent to produce a liquid phase tobacco extract containing nitrosamines and a solid phase comprising extracted tobacco; treating the liquid phase tobacco extract to decompose nitrosamines in the liquid phase; and treating the liquid phase tobacco extract to reduce nitrates and or nitrites therein.

In another embodiment, a method of producing a tobacco extract comprises contacting tobacco with a solvent to produce a liquid phase tobacco extract material containing at least one nitrosamine and a solid phase material comprising extracted tobacco; exposing the liquid phase tobacco extract material to electromagnetic radiation in of a wavelength that causes nitrosamines in the liquid phase to decompose; and treating the liquid phase tobacco extract to reduce nitrosamine decomposition products therein after exposing the tobacco extract to the electromagnetic radiation.

The tobacco extract produced by the methods disclosed therein may be combined with the solid phase material to produce a tobacco product or material.

Accordingly, in another embodiment a method of method of treating tobacco comprises contacting tobacco with a solvent to produce a liquid phase tobacco extract containing nitrosamines and a solid phase comprising extracted tobacco; separating the liquid phase from the solid phase; exposing the liquid phase to electromagnetic radiation in of a wavelength that causes nitrosamines in the liquid phase to decompose; treating the liquid phase after exposure to the radiation to reduce the content of nitrate and/or nitrite ions therein; and combining the treated liquid phase with the solid phase.

In another embodiment, a method for producing a tobacco extract comprises contacting tobacco with a solvent to produce a liquid phase tobacco extract containing nitrosamines and exposing the liquid phase tobacco extract to electromagnetic radiation of a wavelength that causes nitrosamines in the liquid phase to decompose.

We have found that the radiation is particularly effective in decomposing nitrosamines if the liquid phase tobacco extract is exposed to the radiation at a rate of at least 1500 Joules/litre.

Accordingly, in another embodiment, a method of treating tobacco comprises contacting tobacco with a solvent to produce a liquid phase tobacco extract containing nitrosamines and a solid phase comprising extracted tobacco; and exposing the liquid phase tobacco extract to electromagnetic radiation in of a wavelength that causes nitrosamines in the liquid phase to decompose; wherein the liquid phase tobacco extract is exposed to the electromagnetic radiation at a rate of at least 1500 Joules/litre.

Higher radiation rates may be used, for example radiation rates of at least 2500, 3000, 4000, 5000, 6000, 7000, 8000, 9000, 10,000, 15,000, 18,000 or 20,000 Joules/litre may be used.

Electromagnetic radiation in the ultraviolet (UV) region of the spectrum is effective in causing the decomposition of nitrosamines, in particular TSNAs such as NNN, NNK, NAT and NAB.

We have also found that UV radiation may cause relatively less decomposition of nicotine compared with nitrosamines. The methods disclosed herein may therefore be selective in the reduction of nitrosamines relative to nicotine.

Within the electromagnetic spectrum, UV radiation generally has a wavelength shorter than visible light, but longer than X-rays. Typically, UV radiation has a wavelength from 400 nm to 10 nm, shorter than that of visible light but longer than X-rays. The electromagnetic spectrum of UV radiation can be subdivided into a number of ranges, as follows: Ultraviolet A (“UVA”) 400-315 nm, Ultraviolet B (“UVB”) 315-280 nm, Ultraviolet C (“UVC”) 280-100 nm, Near Ultraviolet (“NUV”) 400-300 nm, Middle Ultraviolet (“MUV”) 300-200 nm, Far Ultraviolet (“FUV”) 200-122 nm, Hydrogen Lyman-alpha (“H Lyman-α”) 122-121 nm, Vacuum Ultraviolet (“VUV”) 200-10 nm and Extreme Ultraviolet (“EUV”) 121-10 nm.

A range of equipment is available for the generation of UV radiation of different frequencies. For example UV radiation may be generated in mercury vapour lamps; arc lamps containing xenon, deuterium, mercury-xenon mixtures or metal-halides; tungsten-halogen incandescent lamps; fluorescent lamps such as “black light” fluorescent tubes, which emit long-wave UVA radiation and little visible light and short-wave UV lamps, which emit ultraviolet light with two peaks in the UVC band; gas-discharge lamps containing gases such as argon or deuterium, which produce UV light at particular frequencies, “excimer” lamps, which produce UV radiation at a variety of wavelength bands through the formation of excited diatomic molecules of rare gases and halogens, UV light emitting diodes; and UV-lasers. Electromagnetic radiation having a wavelength in the UV-C range (e.g. 280-210 nm) is convenient to use in the methods disclosed herein because such radiation is readily generated, is not absorbed by air and has a germicidal effect.

The effect of electromagnetic radiation may be enhanced if the liquid phase tobacco extract is in a turbulent state, or subjected to turbulence, whilst being exposed to the electromagnetic radiation.

The effect of the radiation may also be enhanced by treating the tobacco extract to increase the transparency of the tobacco extract to the electromagnetic radiation before exposing the tobacco extract to the electromagnetic radiation. In particular the effect of the treatment with UV radiation may be enhanced by treating the extract to remove material in solution or suspension that reduces the transmission of the radiation by the tobacco extract.

Colourant material in the extract can absorb both visible light and UV radiation. Accordingly, treatment of the extract to reduce the content of colourant material may improve the efficacy of the treatment. A decolourisation or colour reduction treatment that is selective over nicotine, or otherwise has no adverse effect on the flavour, taste or odour to the consumer, is preferred.

Phenolic compounds, especially polyphenols, are among the colourants in tobacco extracts, and may reduce the transmission of UV radiation by such extracts. Examples of polyphenols occurring in tobacco are scopoletin, caffeic acid, chlorogenic acid and rutin. In a further embodiment therefore, the tobacco extract may be treated to reduce the concentration of one or more phenolic compounds therein before exposing the tobacco extract to the electromagnetic radiation. This may be effected by contacting the tobacco extract with an adsorbent or absorbent material selective for polyphenolic material. Examples of such adsorbent or absorbent materials include polyvinyl pyrrolidone (PVP), polyvinylpolypyrrolidone (PVPP), PVI-PVP resins (copolymers of vinyl imidazole and vinyl pyrrolidone) or a suitable ion exchange resin. PVPP is particularly effective in the removal of polyphenols and the quantity of nicotine removed from the extract together with the polyphenols is relatively low. A quantity of for example up to 5%, 10%, or 15% weight of the tobacco used in the production of the extract may remove 50-90% by weight of the polyphenols from the extract.

The effect of the radiation may also be enhanced by treating the tobacco extract to reduce the amount of particulate material therein, especially material having a particle size capable of scattering UV radiation, before the tobacco extract is exposed to the electromagnetic radiation, for example by filtration or centrifugal separation.

In one method, the filter may be a filter bed, a filter column an in-line filter cartridge or a filter screen. The filter may have a mesh size of appropriate size depending upon the particle size of the material in the extract. For example the filter may have a mesh size of 5-10 μm, (Tyler mesh 1250-2500) or less, e.g. 2 μm.

The decomposition of nitrosamines may result in the formation of nitrate and or nitrite moieties in the extract (referred to individually and collectively as NOx moieties). When tobacco is subjected to combustion during the smoking process, it is thought that NOx moieties may be, or may form, nitrosating agents, which lead to the pyrosynthetic formation of TSNAs in tobacco smoke.

In another embodiment, the liquid phase extract may be treated after exposure to the radiation in order to reduce the content of nitrosamine decomposition products in the extract, particularly where the decomposition products include one or more nitrates or nitrites or other potential precursors of nitrosamines. This further treatment may be carried out where the treated tobacco extract is intended to be used in the production of smoking material, for example by combining the liquid phase extract with a smoking material, such as tobacco of reduced nitrosamine content.

For this purpose, after exposure to the radiation, the tobacco extract may be treated with an ion exchange resin capable of exchanging nitrate and/or nitrite ions. Ion exchange resins suitable for the removal of nitrate ions include cationic or anionic cross-linked styrene-divinylbenzene polymers such as those available from Dow Chemical Company and sold under the trade mark DOWEX, and strong- or weak-base anion exchange resins, such as those available from Purolite Corporation under the trade mark PUROLITE. For example, the material sold under the trade mark Purolite A520E is a macroporous strong base anion resin capable of selectively removing nitrate ions from aqueous solution and is composed of polystyrene cross linked with divinyl benzene and having quaternary ammonium functionality. It is available in the form of spherical beads with a particle size in the range 300-1200 μm and with a specific gravity of 1.07.

Adsorbent materials with an affinity for NOx moieties may also be used, for example adsorbent minerals such as sepiolite. Sepiolite is a naturally-occurring hydrated magnesium silicate clay with adsorptive and absorptive properties and an affinity for nitrate and ammonium ions. It has the ideal formula Si₁₂Mg₈O₃₀(OH)₄(OH₂)₄.8H₂O and a structure of talc-type sheets separated by parallel channels that result in needle-like particles. It has a surface area (BET, Nitrogen adsorption) of about 300 m²/g, with a high density of silanol groups (—SiOH) which provide a hydrophilic character to the mineral.

In the methods disclosed herein, the tobacco may be of any suitable individual type or blend, including air-cured, fire-cured, flue-cured, or sun-cured lamina or stem, and may have been processed using any appropriate process. For example, the tobacco may be cut, shredded, expanded or reconstituted.

The solvent with which the tobacco is contacted may be non-aqueous or aqueous. Non-aqueous solvents that may be used are liquid or supercritical carbon dioxide. Aqueous solvents suitable for use include purified water prepared by any suitable purification method, such as distillation and/or de-ionization. Alternatively, the aqueous solvent may be water, possibly mixed with one or more miscible liquids, and/or comprising one or more chemical substances in solution or suspension. For example, in some methods the aqueous solvent may comprise water and one or more of the following: an alcohol, such as ethanol and methanol; one or more metal salts, such as potassium hydroxide, sodium chloride, and magnesium chloride; and/or one or more surfactants, such as SDS. Suitable concentrations of these additives may range from 0%-20% (v/v).

The extraction may be a one-step or two-step process, featuring a first step with the use of an organic solvent, and a second step with the use of one or more of the above aqueous solvents.

In a further embodiment, the liquid phase tobacco extract may be combined with extracted tobacco to produce a tobacco material with reduced nitrosamine content.

In a further embodiment there is provided a tobacco material the nitroso compound content of which, preferably the TSNA content, has been reduced by treatment in accordance with a method disclosed herein.

Nicotine-containing materials with reduced nitrosamine content produced in accordance with the methods may be used in the manufacture of nicotine delivery products.

In one embodiment, a method of manufacturing a nicotine delivery product comprises preparing a material that contains nicotine and other substances, exposing the nicotine containing material to electromagnetic radiation of a wavelength that causes nitrosamines to decompose, treating the nicotine-containing material to reduce nitrosamine decomposition products therein, and incorporating the treated nicotine-containing material in the nicotine delivery product.

For example, liquid phase tobacco extract materials with reduced nitrosamine content may be concentrated and the concentrate combined with the solid phase, for example by spraying, to produce a tobacco material with reduced nitrosamine content. The tobacco material may be incorporated in combustible tobacco products, e.g. smoking articles such as cigarettes, cigarillos and cigars, or in heated, non-combustion products in which a flavoured aerosol is produced by heating, but not burning, the tobacco material, or in tobacco intended for oral consumption, for example snus or, snuff. Liquid phase nicotine containing material may be used in aerosol and volatilisation products, or provide a source of nicotine in the matrix of a transdermal patch or in oral non-tobacco products, such as chewing gum.

Tobacco material suitable for smoking may be packed separately for assembly by the consumer into smoking articles, or may be incorporated into smoking articles, ready for consumption. The smoking article may take any conventional form, for example a cigarette, cigar or cigarillo. In particular the smoking article may comprise a rod of smoking material optionally in a wrapper, with or without a filter. The wrapper may be of paper, tobacco leaf, reconstituted tobacco or a tobacco substitute. Alternatively, where, for example, the smoking article is intended to produce low emissions of side-stream smoke, or lower levels of pyrolysis products in the mainstream smoke, the wrapper may be composed of non-combustible inorganic material such as a ceramic material. The filter may be of any suitable material, for example fibrous cellulose acetate, polypropylene or polyethylene, or paper.

Nicotine solutions with reduced nitrosamine content may be incorporated in the consumable liquid used in aerosol or vapour generating devices such as electronic cigarettes. Such liquids typically comprise up to 75 wt % of a carrier such as glycerol or propylene glycol, up to 5 wt % nicotine, the balance being water and flavourants.

Specific embodiments of the methods of treating material containing nicotine or methods of producing tobacco extract, equipment used in such methods and materials produced by such methods will now be described by way of example only with reference to the accompanying drawings in which:

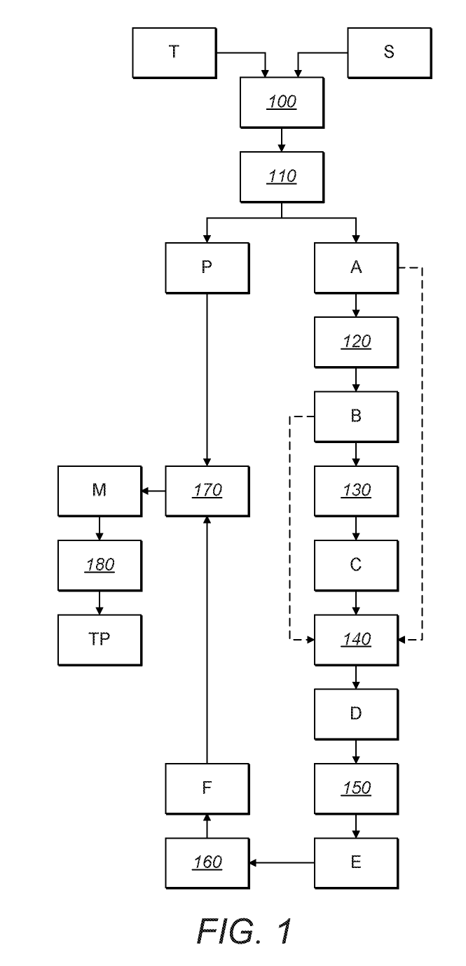

FIG. 1 is a flow chart showing an example of a process in which the method of production of tobacco extract is incorporated in a method of manufacturing tobacco material and tobacco products such as cigarettes;

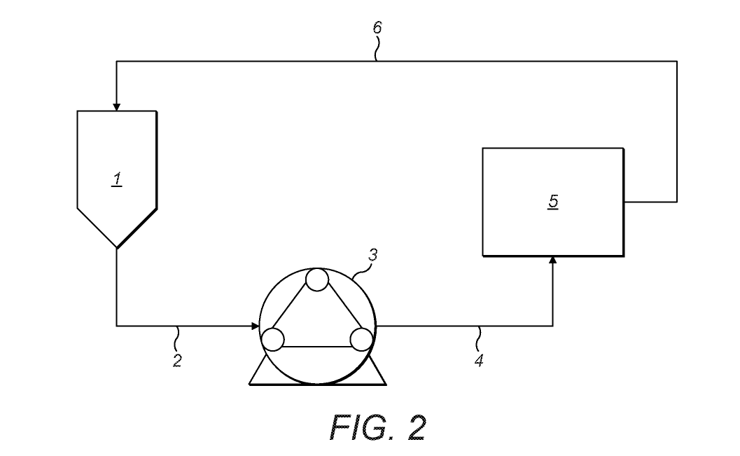

FIG. 2 is a diagram of laboratory-scale equipment that may be used to carry out one embodiment of the method;

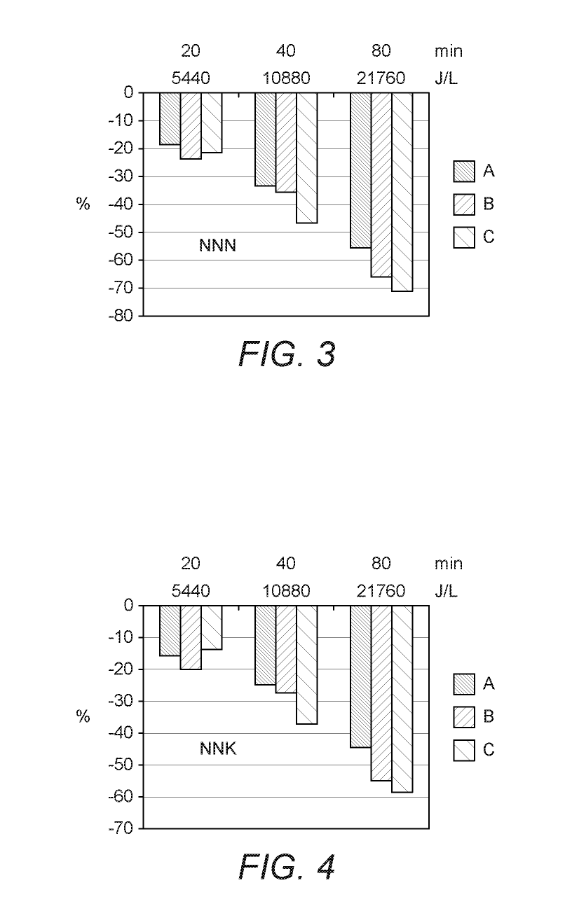

FIG. 3 is a chart showing the % reduction in NNN in samples of a tobacco extract treated in accordance with a first embodiment of the method, using in the equipment of FIG. 2;

FIG. 4 is a chart showing the % reduction in NNK in the samples of the tobacco extract to which FIG. 3 refers;

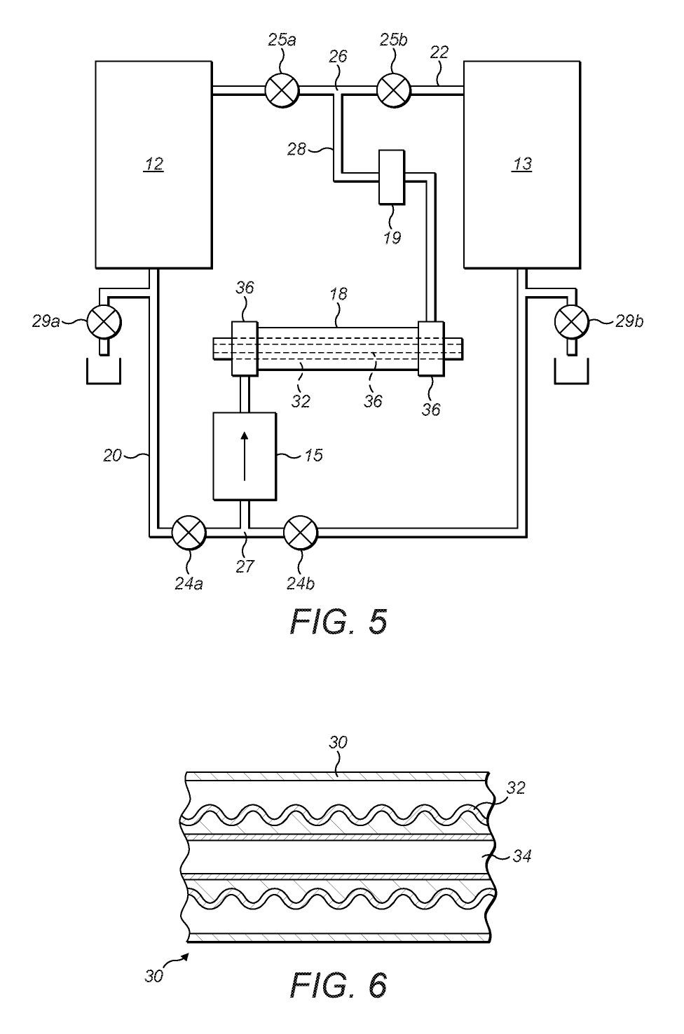

FIG. 5 is a schematic view of equipment that may be used to carry out the method on a larger scale;

FIG. 6 is a diagrammatic cross section through an ultra-violet light lamp unit incorporated in the equipment of FIG. 5;

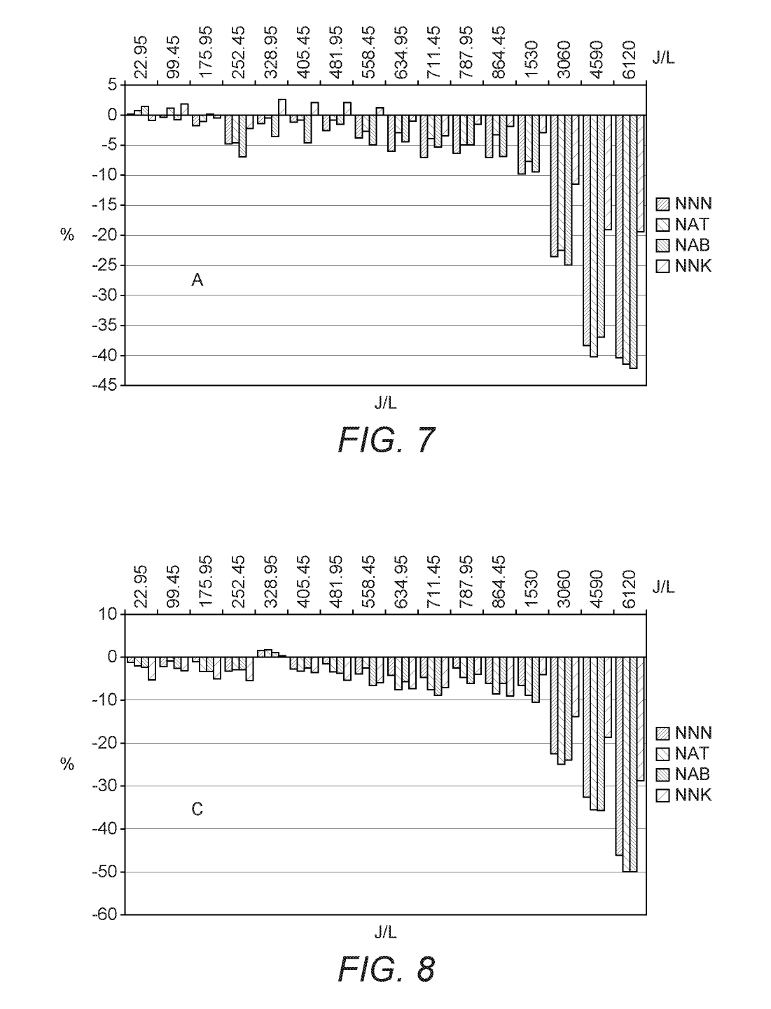

FIG. 7 is a chart showing the variation with UV exposure levels of the reductions in levels of NNN, NAT, NAB and NNK in samples of the liquid phase extract treated in accordance with a second embodiment of the method, using in the equipment of FIGS. 5 and 6;

FIG. 8 is a chart showing the variation with UV exposure levels of the reductions in levels NNN, NAT, NAB and NNK in samples of the liquid phase extract treated in accordance with a third embodiment of the method using in the equipment of FIGS. 5 and 6;

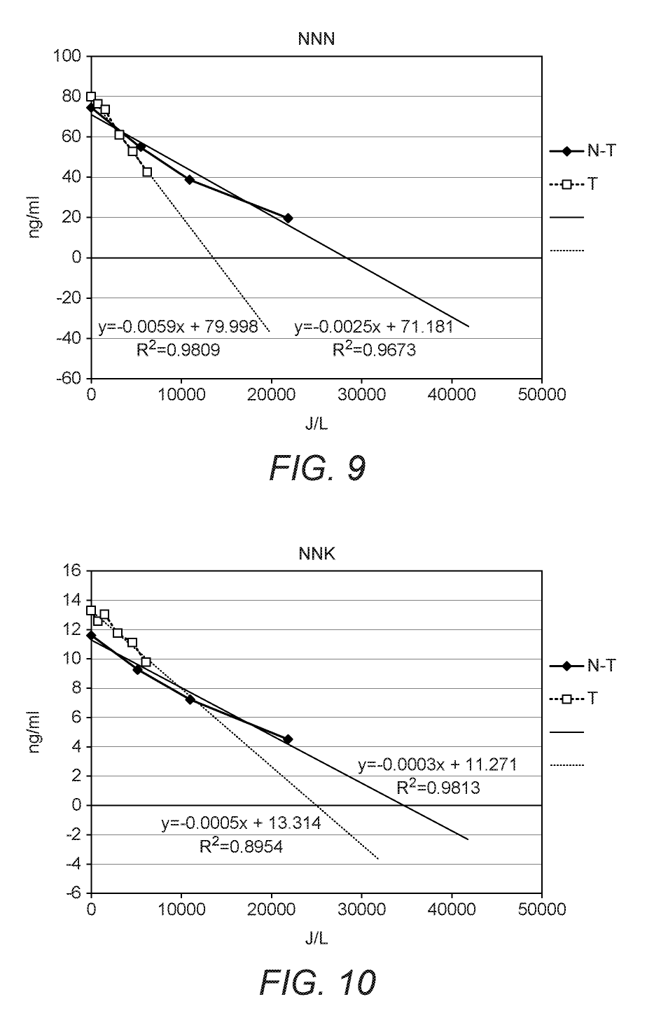

FIG. 9 is a chart comparing the variation in the reduction of NNN levels in samples of the liquid phase extract treated in accordance with the first and third embodiments of the method;

FIG. 10 is a chart similar to FIG. 9 comparing the variation in the reduction of NNK levels in the same samples of the liquid phase extract;

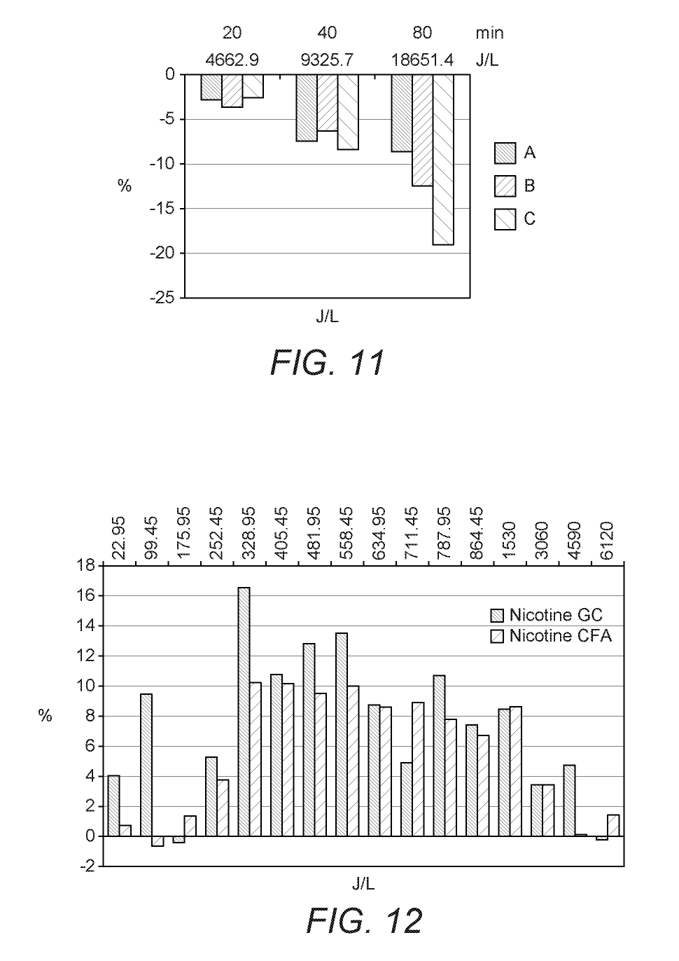

FIG. 11 is a chart showing the variation with UV exposure levels of the reduction of nicotine levels in samples of the liquid phase extract treated subjected to the first embodiment of the method;

FIG. 12 is a chart showing the variation with UV exposure levels of the reduction of nicotine levels in samples of the liquid phase extract treated subjected to the second embodiment of the method;

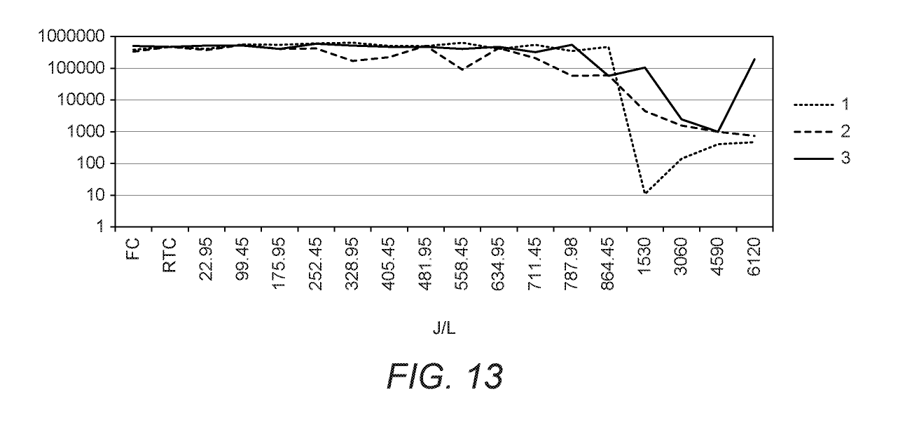

FIG. 13 is a chart showing the variation of bacterial colony count with exposure levels in samples of liquid phase extract in the reduction of nicotine levels in samples of the liquid phase extract treated subjected to the method;

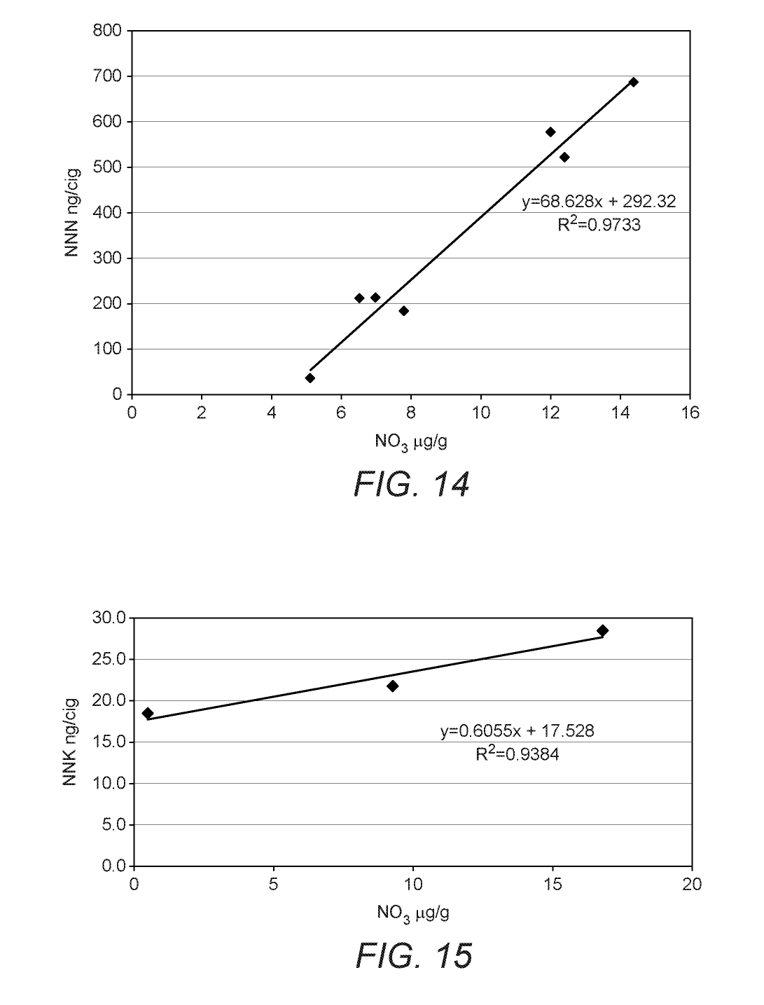

FIGS. 14 and 15 are charts showing the variation of NNN in tobacco smoke with the nitrate content of the tobacco before combustion;

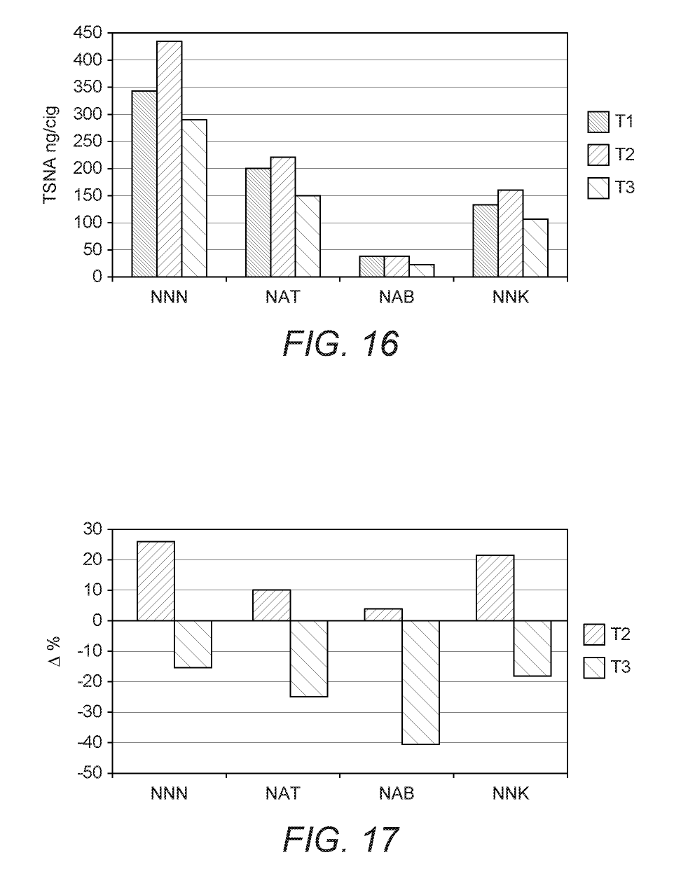

FIG. 16 is a chart comparing the content of four tobacco-specific nitrosamines in tobacco smoke from tobacco treated in accordance with the method disclosed herein with tobacco treated otherwise; and

FIG. 17 is a chart showing the differences in levels of four TSNAs in smoke from treated tobacco relative to the levels in the smoke from untreated tobacco.

One example of a method of producing tobacco extract is described below with reference to the flow-chart of FIG. 1. In this method, cured leaf tobacco T and a solvent S are contacted in an extraction stage 100 for a period and under treatment conditions such that materials in the tobacco, including nitrosamines, are transferred from the tobacco into the solvent. In a separation stage no, the mixture is separated, for example by mechanical treatment such as pressing and/or centrifugal separation, to produce a liquid phase tobacco extract A and a solid phase P that comprises extracted tobacco.

The liquid phase extract A is then treated in a filtration stage 120 to reduce the particulate content thereof to form a filtered liquid phase extract B.

The liquid phase extract B is then treated in a decolourisation stage 130 to form a filtered and decolourised liquid phase extract C.

In an alternative method, the filtration stage 120 and the decolourisation stage 130 may be carried out in the reverse order.

In an exposure stage 140, the filtered and decolourised extract C is exposed to electromagnetic radiation of a wavelength that causes decomposition of nitrosamines in the extract, for example UV-C radiation, to form a liquid phase extract D of reduced nitrosamine content that also contains nitrosamine decomposition products, including NOx moieties.

In an NOx moieties reduction stage 150 the extract D with reduced nitrosamine content is treated to reduce the content of nitrates and/or nitrites in solution to form a liquid phase extract E with reduced levels of NOx moieties.

In a concentration stage 160, water is removed from the NOx-reduced liquid extract E to produce a concentrated liquid phase extract F.

In a re-combination stage 170, the concentrated liquid phase extract F is combined with the solid phase extract P from the separation stage 110, for example by spraying the liquid phase extract on to the solid phase extract P in a double-cone blender, to produce a tobacco material M of reduced nitrosamine content that is also low in NOx moieties formed by decomposition of the nitrosamines extracted from the original tobacco material T.

In a manufacturing stage 180, the tobacco material M may be processed to produce tobacco products TP, such as cigarettes, in a manner known to the person skilled in the art, in steps including, for example blending, conditioning and assembly in cigarette-making machinery.

In the following illustrative examples of the method, analyses and other tests are performed on samples of tobacco extracts corresponding to the extracts A, B and C in FIG. 13. For the purposes of comparison, extracts A, B and C are subject to exposure to electromagnetic radiation treatment with and without the intermediate treatment stages of filtration and decolourisation. The separate treatment paths for these samples are illustrated in broken lines in FIG. 13.

A. Preparation of raw liquid phase extract (stages 100, 110). A 4.5 kg batch of a Burley tobacco blend is comminuted by cutting the tobacco into strips at 35 cuts per inch (approximately 0.7 mm in width). The cut tobacco T is contacted with 80 litres of de-ionised water for 15 minutes at 550-60° C. in an agitated washing machine having a spin-drying drum. The resulting material is mechanically separated by spinning the washing machine drum to produce a liquid phase tobacco extract, and a fibrous solid phase P comprising the extracted tobacco. The liquid phase extract is then centrifuged to separate larger particles of solid material, which may be combined with the solid phase P or discarded.

The liquid phase extracts of seven similar batches are combined and cooled to a temperature between 0° and 10° C. The liquid phase extract contains nitrosamines, nicotine, colourants, including polyphenols, and other substances in solution in water, together with particles of solid material in suspension. At the end of this stage, the extract A is dark brown in colour and turbid.

B. Preparation of filtered liquid phase extract (stage 120). The extract from Stage A is subjected to a filtration treatment by passing the extract through a 5 μm cartridge filter to remove particles greater than 5 μm and pumped to a holding tank. The filtered extract B is dark brown in colour but less turbid and more transparent than the raw, unfiltered extract A.

C. Preparation of filtered and decolourised liquid phase extract (stage 130). The filtered extract of Stage C is subjected to a decolourisation (or colour reduction) treatment in which the extract is clarified and increased in transparency by re-circulating the extract for a period of about 30 minutes at a temperature of from 5° to 10° C. through a treatment chamber containing 15-20 kg of PVPP, which adsorbs polyphenol materials from the extract. After contact with the PVPP, the extract is passed through a filter press to remove PVPP particles therefrom. The resulting extract is lighter brown in colour than that of Stage B, and more transparent, having an increased transparency to visible light.

It will be appreciated that in another embodiment of the treatment method, the filtration and decolourisation processes of Stages B and C may be carried out in the reverse order. In the following tests, the samples from Stage A were first filtered and then decolourised.

D. Preparation of UV-exposed liquid phase extracts (stage 140). In a series of experimental runs, samples of the extract at Stage A, B and C are each exposed to UV-C radiation, with or without turbulence, for periods of up to 80 minutes. Two different exposure systems are used, a small scale system, described below with reference to FIG. 2 and a larger scale system, described below with reference to FIGS. 4 and 5.

E. Preparation of NOx-reduced extracts (stage 150). The UV-treated extract of Stage D is subjected to treatment to reduce nitrates and/or nitrites by mixing the extract for a period of about 30 minutes at a temperature of from 5° to 10° C. through a treatment chamber containing 75 litres of a granular adsorbent or absorbent material selective for nitrates, such as Purolite A520E ion-exchange resin, referred to above. After contact with the nitrate adsorbent material, the extract is filtered to remove solid particles therefrom, using a vibratory sieve with a 20 micron mesh.

Referring to FIG. 2, laboratory-scale equipment suitable for exposing a non-turbulent stream of the tobacco extract to UV light is illustrated schematically. The equipment comprises a reservoir 1 of 0.5 litre capacity for storing a sample of liquid phase extract. The reservoir 1 is connected by a supply pipe line 2 of flexible plastics material to a peristaltic pump 3 which, when activated, pumps the extract from the reservoir 1 through a delivery pipe line 4 to the inlet of a ultra-violet radiation (UV) treatment chamber 5 at a controlled flow rate of 12 litres per hour. Liquid entering the chamber 5 is exposed to a field of ultra-violet radiation generated by an electrically powered lamp or tube, there by exposing the extract to the radiation. The treatment chamber 5 may for example comprise a laboratory-based ultra-violet light water treatment device, such as that sold in the United Kingdom under the trade mark Vecton 300 by Tropical Marine Centre Ltd., containing a 16 watt UV tube delivering 3.2 watts of UV-C radiation, with its most significant radiation at 253.7 nm, and an efficiency of about 85% as a result of absorption of radiation in the system. A return pipe line 6 connects an outlet of the treatment chamber 5 with the reservoir 1.

On each experimental run, the equipment charged with a 600 ml sample of tobacco extract at Stage A, B or C of the preparative process. The UV light is turned on and the pump 3 is operated at a rate of 12 litres per hour to circulate the liquid phase extract from the reservoir 1, through the treatment chamber 5 and back to the reservoir 1 for a desired period of time. As a result, each sample of the extract is exposed to a controlled dosage of ultraviolet radiation. In the examples described below, circulation of the sample through the chamber 5 for 20, 40, 80 or 130 minutes results in dosages of ultraviolet radiation of about 5440, 10880, 21760 and 35360 Joules per litre respectively.

At the end of each exposure, the sample of the liquid phase tobacco extract is analysed for its content of the tobacco specific nitrosamines and nicotine using liquid chromatography mass spectrometry (LCMS) for TSNAs and gas chromatography (GC) and continuous flow analysis (CFA) for nicotine. Bacterial growth tests were also performed on the samples using aerobic colony counting.

Referring to FIGS. 3 and 4, the bar charts show the % reductions in NNN (FIG. 3) and NNK (FIG. 4) in three sets of three samples of the liquid phase tobacco extract at stages A, B and C of the treatment method described above, after exposure to UV light under non-turbulent flow conditions in the equipment of FIG. 2. The reductions in content for extracts at stages A B and C are illustrated respectively by dark, intermediate and light shading of the bars in the chart. The exposure periods for the three sets of samples, in terms of the period of exposure, in minutes, and the corresponding UV radiation delivered in Joules per litre of extract, are shown above the respective bars on the chart. The % reductions are calculated with reference to a control sample of the extract at Stage A before exposure UV radiation, and kept at room temperature for the same period as the samples exposed to UV radiation.

The reductions in NNN and NNK in the samples with the shortest exposure levels on the left side of the chart, which are no more than 6,000 J/l are between 15 and 25%, and possibly not statistically significant within the limits of analytical accuracy. The reductions of NNN and NNK in the samples with intermediate exposure periods, in the centre of the chart which are in excess of 6000 J/l, and at least 9,000 or 10,000 J/l become more statistically significant and indicate that exposures to UV radiation of at least 5000, 6,000, 7,000, 8,000, 9,000 or 10,000 Joules/litre begin to have a significant effect in decomposing the TSNAs and therefore reducing their detected levels in the tobacco extract. The reductions in the samples with the highest rates of exposure, to the right of the chart, are even more significant. With a rate of exposure of no less than 12,000, 15,000, 18,000 J/l, and up to 20,000-25,000 J/l of UV-C light, reductions of up to 70% for NNN and up to 60% for NNK are detected.

Furthermore, by comparing the reductions in TSNA levels in the samples exposed to UV-C radiation immediately after at stages A B and C, it can be seen that the exposure to UV light is more effective after filtration (Stage B) than before filtration (Stage A), and still more effective after filtration and decolourisation (Stage C).

Referring to FIG. 5, larger scale equipment for exposing tobacco extract to UV light is illustrated diagrammatically. In one embodiment, the equipment may be a UV liquid treatment system sold by Surepure, Inc. of Newlands, South Africa under the trade mark SurePure Turbulator, some features of which are described in patent specification WO 01/37675. The equipment comprises a wheeled carriage on which are mounted first and second storage tanks 12, 13, each with a capacity of 30 litres, an electrically-driven pump 15 which pumps liquid in the direction of the arrow in FIG. 5, and a tubular UV treatment chamber 18. These components are connected by a system of stainless steel pipes so that the contents of one tank may be either circulated from one tank through the treatment chamber 18 and returned to the same tank in a desired number of cycles, or transferred to the other tank, each time passing through the treatment chamber 18. On each pass through the treatment chamber 18, the liquid is exposed to a dose of UV radiation.

The system of pipes comprises a first branch 20, connecting an inlet in the bottom of the first tank 12 with a similar inlet in the bottom of the second tank 13, and a second branch 22 connecting an inlet near the top of the first tank 12 with an inlet near the top of the second tank 13. First and second stop valves 24a, 24b are connected in series in the first branch 20 in communication with the bottom inlets to the first and second tanks 12, 13 respectively. Each stop valve is movable between an open position, in which liquid can flow through the valve, and a closed position in which the flow of liquid through the branch is prevented. Third and fourth stop valves 25a and 25b, of similar construction to the first and second, are connected in series in the second branch 22 in communication with the top inlets to the first and second tanks 12, 13 respectively. T-junction connectors 26, 27 are provided between each pair of stop valves and are connected to each other by a third branch 28 of the system of pipes, which provides a series connection between the pump 15, the treatment chamber 18 and a meter 19, which monitors the flow of liquid through the system. Drain valves 29a, 29b are provided in the first branch 20 pipe system adjacent the bottom inlets to the first and second tanks 12, 13 to allow the system to be drained and flushed clean.

The tubular UV treatment chamber 18 is illustrated in more detail in FIG. 6. The treatment chamber 18 comprises a tubular outer housing 30 of stainless steel, a tubular sheath 32 mounted within and coaxially with housing 30, and a fluorescent UV tube 34 mounted within and coaxially with the sheath 32. The UV tube has a rating of 36 watts capable of delivering 30 Watts of UV-C radiation with an efficiency reduced to about 85% as a result of absorption of radiation in the system. The ends of the tubular assembly are mounted in water-tight manifolds 36 (FIG. 4) to which the system of pipes is connected so that liquid to be exposed to UV radiation can flow between the sheath 32 and the external surface of the UV tube 34. The ends of the tube 34 extend beyond the manifolds and are coupled to insulated electrical connections through which power is supplied to the tube 34 without risk of contact with the liquid.

The sheath 32 has an inner surface that exhibits radial projections, for example in the form of corrugations, the effect of which is to produce turbulence in the liquid flowing through the sheath in the field of UV radiation established between the tube 34 and the sheath when the equipment is in use. The resulting turbulence improves the penetration of the extract by the UV-C radiation.

On each experimental run, the first tank 12 is charged with a 550 litre sample of tobacco extract, the UV tube is turned on, the first and third stop valves 24a, 25a, are opened, the second and fourth stop valves 24b, 25b, are closed and the pump 15 is operated at a rate of about 2000 litres per hour to circulate the liquid phase extract from the first tank 12, through the treatment chamber 18 and thence back to the first tank 12.

At the end of the treatment period the treated tobacco extract is drained from the first tank 12 through the drain valve 29a.

Depending on the period of operation, the extract is exposed to varying levels amounts of ultraviolet radiation. The relationship between the experimental run times (in seconds and minutes) and the resulting rate of exposure of the liquid extract to UV light (in Joules/litre) is set forth in the following table:

| | UV Exposure rate (Joules/litre) |
|---|---|
| Run Time (Seconds) | |
| 0 | 0.0 |
| 18 | 23.0 |
| 78 | 99.5 |
| 138 | 176.0 |
| 198 | 252.5 |
| 258 | 329.0 |
| 318 | 405.5 |
| 378 | 482.0 |
| 438 | 558.5 |
| 498 | 635.0 |
| 558 | 711.5 |
| 618 | 788.0 |
| 678 | 864.5 |
| Run time (Minutes) | |
| 20 | 1530.0 |
| 40 | 3060.0 |
| 60 | 4590.0 |
| 80 | 6120.0 |

At the end of each exposure, the sample of the liquid phase tobacco extract is analysed for the contents of tobacco specific nitrosamines and nicotine and for bacterial growth as described above.

Referring to FIG. 7, the bar chart comprises 16 groups of four bars, one group for each of sixteen samples of the liquid phase tobacco extract at Stage A of the treatment method described above (unfiltered and not decolourised), after exposure for different periods to UV light under turbulent flow conditions in the equipment of FIG. 5. The lengths of the bars in each group indicate, from left to right, the % reduction in NNN, NAT, NAB and NNK respectively. The exposure periods for the samples in terms of the UV radiation delivered in Joules per litre of extract, are shown above the respective groups of bars on the chart. The % reductions are calculated with reference to a control sample of the extract at Stage A before exposure UV radiation, kept frozen until the samples exposed to UV radiation were analysed, and analysed at the same time as the exposed samples.

It can be seen from FIG. 7 that the reductions in the nitrosamines in the samples with the shorter exposure levels, below about 1500 Joules/litre, are not statistically significant within the limits of analytical accuracy. The reductions of NNN and NNK in the samples with longer exposures are however statistically significant and indicate that exposures to UV radiation greater than about 1500, 1600, 2000 or 2500 Joules/litre, begin to have a significant effect in decomposing the TSNAs and therefore reducing their detected levels in the tobacco extract. In this respect, the four sets of results on the right hand side of FIG. 7 indicate that exposures to UV radiation of at least 3000, 4000, 5000 or 6000 Joules/litre have increasingly significant effects in decomposing the TSNAs. Higher levels of exposure would be expected to produce correspondingly higher levels of reduction.

FIG. 8 summarises the results of similar tests carried out on samples of tobacco extract at Stage C, i.e. samples that have been filtered to 5 μm and decolourised, and then subjected to UV radiation in the equipment of FIG. 5 as described above. With a rate of exposure of greater than 1500, 1600, 2000, 2500, 3000 or 4000 J/l, especially around approximately 6000 J/l of UV-C light, reductions of up to 50% for NNN and NAB are detected.

By comparing the reductions in nitrosamine levels in FIGS. 7 and 8, it can be seen that the exposure to UV light is more effective after filtration and decolourisation (Stage C, FIG. 8), higher levels of reduction of nitrosamines being detected for comparable rates of exposure to UV radiation. However, a minimum exposure level in the range 1500-3000 J/l, possibly at least 2000 or 2500 J/l appears to be required before a significant reduction in TSNA levels is achieved.

Referring to FIGS. 9 and 10, the data relating to reductions of NNN (FIG. 9) and NNK (FIG. 10) in filtered and decolourised samples treated using the procedure and equipment described above with reference to FIG. 2 (UV exposure under non-turbulent flow conditions) is compared with the results for the reductions of NNN and NNK in similar samples treated using the procedure and equipment of FIG. 5 (UV exposure under turbulent flow conditions). The data points relating to non-turbulent treatment are connected by a solid line N-T, the data points relating to turbulent flow by a broken line T. The graph represents the variation of the reduction in nitrosamine, measured in ng/l (vertical axis) with the level of exposure to UV radiation, measured in Joules/l (horizontal axis). The two sets of data are overlaid with best-fit straight lines, shown correspondingly in solid and broken lines. It can be seen from the slopes of the best fit straight lines that exposing the extract to UV light and turbulent flow has a greater effect on nitrosamine reduction with increasing exposure levels than exposure in non-turbulent conditions.

Referring to FIG. 11, the bar charts show the % reduction in nicotine in three sets of three samples of the liquid phase tobacco extract at stages A, B and C of the treatment method described above, after exposure to UV light under non-turbulent flow conditions in the equipment of FIG. 2. The reductions in content for extracts at stages A, B and C are illustrated respectively by dark, intermediate and light shading of the bars in the chart. The exposure periods for the three sets of samples, in terms of the period of exposure, in minutes, and the corresponding UV radiation delivered in Joules per litre of extract, are shown above the respective bars on the chart. The % reductions in nicotine are calculated with reference to a control sample of the extract at Stage A before exposure UV radiation, and kept at room temperature for the same period as the samples exposed to UV radiation.

The reductions in nicotine in all the samples tested are less than 20% even with the longest exposure periods.

The selectivity of a treatment method for nitrosamines relative to nicotine may be calculated as the relative weight percentage reductions of the nitrosamine to nicotine caused by the process when carried out a mixture containing both substances:

$$Selectivity for nitrosamine relative to nicotine = \frac{wt \% nitrosamine extracted}{wt \% nicotine extracted}$$

Comparing the reductions in NNN and NNK shown in FIGS. 3 and 4 with the reductions in nicotine shown in FIG. 11, the method achieves a selectivity of 71/19, or 3.7, for NNN and 59/19, or 3.1, for NNK.

Whilst not wishing to be bound by any theory, it may be the case that the NO group on the TSNA molecules are broken or disrupted as a result of the UV radiation breaking the chemical bond. The reaction of the resulting fission products of the NO bond may account for the increase in nitrate and or nitrite content of the treated extracts. Further, the relatively weak effect of UV radiation upon nicotine concentrations in the extracts tested may be accounted for by the absence of NO groups in the nicotine molecule.

FIG. 12 is a bar chart showing % reductions in nicotine content of sixteen samples of the liquid phase tobacco extract at Stage C of the treatment method described above, with different levels of exposure to UV light under turbulent flow conditions using the equipment of FIG. 5. Two methods of analysis of nicotine were used, namely gas chromatography (GC) and continuous flow analysis (CFA). The results indicate variations of nicotine levels that are for the most part not statistically significant within the limits of analytical accuracy, but which appear to indicate that at the levels of UV exposure that begin to be effective for reduction of nitrosamine levels, e.g. 1500 to 3000 J/l or more, the reduction in nicotine levels is less than about 5%.

FIG. 13 is a chart showing the variation with UV light exposure of the bacterial colony count in three sample of tobacco extract at stage C of the method described above (filtered and decolourised) after treatment with UV radiation under turbulent flow conditions described above with reference to FIG. 5. The bacterial colony count for control samples of untreated extract kept frozen (FC) and at room temperature (RTC) are also shown. The differences in the results for the three samples (referenced 1, 2 and 3) at each level of exposure is consistent with the normal variations observed in bacterial growth studies. Nevertheless the chart is indicative that exposure to UV radiation at less than about 1000 J/l has little effect upon bacterial growth, but that at levels of exposure greater than about 1000 J/l, bacterial growth is reduced.

FIGS. 14 to 16 demonstrate the effect of the presence of nitrites in cured tobacco on the TSNA content of tobacco smoke.

Referring to FIG. 14, seven different samples of tobacco materials are prepared and analysed for their nitrate content. The first consists of 100% Burley, having the highest nitrate content, the second consists of 100% Virginia tobacco and has the lowest nitrate content, and the remaining five samples consist of mixtures of the Burley and Virginia tobaccos in different ratios with intermediate nitrate contents. The samples are made into cigarettes for smoking and then smoked in a cigarette smoking machine using the Health Canada intensive (HCI) smoking regime. The smoke generated is analysed for its content of NNN.

FIG. 14 illustrates the variation of the concentration of NNN (in ng/cigarette) in the smoke with the nitrate content of the tobacco (in μg/g). The results fit a straight line with a positive slope, indicating a correlation between the presence of nitrates in unsmoked tobacco and the creation of nitrosamines in tobacco smoke.

Referring to FIG. 15, three samples of the same blend of Virginia tobacco are combined with increasing quantities of nitrate, incorporated into cigarettes and smoked under the HCI smoking regime. The amounts of NNK in the tobacco smoke are measured. FIG. 15 is a graph illustrating the variation of the concentration of NNN (in ng/cigarette) in the smoke with the nitrate content of the tobacco (in μg/g). The results fit a straight line with a positive slope, indicating a strong correlation between the presence of nitrates in unsmoked tobacco and the creation of nitrosamines in tobacco smoke.

Referring to FIG. 16, a sample of Burley tobacco T₁ is extracted with water at a rate of 3 kg tobacco to 80 litres of water and separated according to the process described with reference to stages 100 and 110 of FIG. 1 to produce a first tobacco extract T₂. Part of the first extract T₂ is held in storage and the remainder is subjected to a further treatment step in which the extract T₁ is treated with granular Purolite at a rate of 75 litres of Purolite per 560 litres of water according to the process as described with reference to stage 150 of FIG. 1 and then filtered in a vibratory sieve to produce a second extract T₃ with a nitrate content of about 10% that of the untreated extract (a reduction of about 90%).

The extracts T₂ and T₃ are each concentrated a thin-film, spinning cone evaporator and then separately recombined with the solid phase material obtained from the extraction and separation stages, using a double cone blender. The tobacco materials formed by recombination of the extracted tobacco and the extracts T₂ and T₂ are dried to produce smoking material suitable of incorporation in cigarettes of a standard size. The original tobacco material Ti and the materials formed using the two extracts T₂ and T₃ are made into cigarettes are smoked in a smoking machine in accordance with the HCI regime. The smoke is analysed for TSNAs, specifically NNN, NAT, NAB and NNK.

FIG. 16 is a bar chart consisting of four groups of three bars indicating, from left to right respectively concentrations of NNN, NAT, NAB and NNK in the smoke generated, in nanograms per cigarette. Within each group of bars in the chart, the three bars indicate, from left to right, the levels of the TSNA in the untreated tobacco T₁, and the tobacco products incorporating the extracts T₂ and T₃ respectively.

It can be seen that the levels of nitrosamines in the smoke generated from the smoking material made using the second tobacco extract T₂ are higher than in the smoke from the smoking material made using the untreated tobacco extract T₁. However the smoke from the material made using the third extract T₃, which has been treated to reduce nitrates, has a lower content of TSNAs than the smoke from the material made using the untreated tobacco T₁.

FIG. 17 illustrates graphically the % difference (Δ%) in levels of the four TSNAs NNN, NAT, NAB and NNK in the smoke from the samples prepared using the two extracts T₂ and T₃ relative to the levels in smoke from the samples prepared using untreated tobacco T₁.

These data indicate that the combustion process in tobacco may result in increased levels of TSNA in tobacco smoke, possibly as a result of pyrosynthesis from TSNA precursors in the tobacco. Furthermore, the data indicate that the treatment of tobacco to reduce the level of nitrates in tobacco results in a decrease of TSNAs in tobacco smoke. This suggests that nitrates are possible pyrosynthetic precursors of TSNA, and that treatment of tobacco to reduce the level not only TSNAs but also their precursors, in particular nitrates, may result in a decrease in TSNAs in tobacco smoke.

The various embodiments described herein are provided as a representative sample of embodiments only, and are not exhaustive or exclusive. It is to be understood that other embodiments may be utilised and modifications may be made, comprising, consisting of, or consisting essentially of various appropriate combinations of the disclosed elements, components, features, parts and steps, and means other than those specifically described herein.

1. A method of treating a material containing nicotine and at least one nitrosamine to reduce the quantity of nitrosamine therein, which method comprises exposing the material to electromagnetic radiation of a wavelength that causes the nitrosamine in the material to decompose; wherein the material is exposed to the electromagnetic radiation at a rate of at least 1500 Joules/litre.

2. A method of treating a material containing nicotine and at least one nitrosamine to reduce the quantity of nitrosamine therein, which method comprises exposing the material to electromagnetic radiation in of a wavelength that causes nitrosamines in the material to decompose; and further treating the material to reduce nitrosamine decomposition products therein after exposing the tobacco extract to the electromagnetic radiation.

3. A method according to claim 1 or claim 2 wherein the material containing nicotine and at least one nitrosamine comprises a liquid phase tobacco extract material produced by contacting tobacco with a solvent.

4. A method of producing a tobacco extract comprising contacting tobacco with a solvent to produce a liquid phase tobacco extract material containing nitrosamines and exposing the liquid phase tobacco extract material to electromagnetic radiation of a wavelength that causes nitrosamines therein to decompose; wherein the liquid phase tobacco extract material is exposed to the electromagnetic radiation at a rate of at least 1500 Joules/litre.

5. A method of producing a tobacco extract comprising contacting tobacco with a solvent to produce a liquid phase tobacco extract material containing nitrosamines and a solid phase comprising extracted tobacco; exposing the liquid phase tobacco extract to electromagnetic radiation in of a wavelength that causes nitrosamines in the liquid phase to decompose; and treating the liquid phase tobacco extract material to reduce nitrosamine decomposition products therein after exposing the tobacco extract to the electromagnetic radiation.

6. A method of producing a tobacco extract comprising contacting tobacco with a solvent to produce a liquid phase tobacco extract material containing nitrosamines and a solid phase material comprising extracted tobacco; treating the liquid phase tobacco extract material to decompose nitrosamines in the liquid phase; and treating the liquid phase tobacco extract material to reduce the amount of nitrosamine decomposition products therein.

7. A method of producing a tobacco extract comprising contacting tobacco with a solvent to produce a liquid phase tobacco extract material containing nitrosamines and a solid phase material comprising extracted tobacco; treating the liquid phase tobacco extract material to decompose nitrosamines in the liquid phase; and treating the liquid phase tobacco extract to reduce the amount of nitrates and or nitrites therein.

8. A method of producing a tobacco material comprising producing a tobacco extract in accordance with any one of claims 4 to 7 and combining the treated liquid phase extract material with the solid phase material.

9. A method according to any one of claims 2, 3 or 5 to 8 wherein the exposure to the electromagnetic radiation at a rate of at least 1500 Joules/litre.

10. A method according to any one of claims 1 to 8 wherein the exposure to the electromagnetic radiation at a rate of at least 2500 Joules/litre.

11. A method according to any one of claims 1 to 10 wherein the electromagnetic radiation has a wavelength in the UV-C range.

12. A method according to any one of claims 1 to 11 wherein the electromagnetic radiation is applied to liquid phase material that is in a turbulent state whilst being exposed to the electromagnetic radiation.

13. A method according to any one of claims 1 to 12 wherein the electromagnetic radiation is applied to liquid phase material, and further comprising treating the material to increase its transparency to the electromagnetic radiation before it is exposed thereto.

14. A method according to claim 13 wherein the material is treated to reduce the concentration of polyphenols therein before exposing the tobacco extract to the electromagnetic radiation.

15. A method according to claim 14 wherein the concentration of polyphenols in the material is reduced by adsorption, absorption or ion exchange.

16. A method according to claim 15 wherein the concentration of polyphenols in the material is reduced by contacting the material with polyvinylpolypyrrolidone

17. A method according to any one of claims 1 to 16 wherein the electromagnetic radiation is applied to liquid phase material, and further comprising treating the tobacco extract to reduce the amount of particulate material therein before it is exposed to the electromagnetic radiation.

18. A method according to claim 17 where in the material is filtered to reduce the amount of particulate material therein before it is exposed to the electromagnetic radiation.

19. A method according to any one of claims 1, 4 and 7 and any of claims 8 to 18 as dependent therefrom, further comprising treating the material to reduce nitrosamine decomposition products therein after exposing it to the electromagnetic radiation.

20. A method according to any one of claims 1, 4 and 7 and any one of claims 8 to 18 as dependent therefrom further comprising treating the material to reduce the concentration of nitrate ions therein after exposing it to the electromagnetic radiation.

21. A method according to claim 20 wherein the material is treated with an ion exchange resin that reduces the concentration of nitrate ions therein.

22. A method according to claim 20 wherein the material is treated with an adsorbent material that reduces the content of nitrate ions therein.

23. A method according to any one of claims 1 to 22 wherein the material is produced by contacting tobacco with an aqueous solvent.

24. A method of method of treating tobacco comprising contacting tobacco with a solvent to produce a liquid phase tobacco extract containing nitrosamines and a solid phase comprising extracted tobacco; separating the liquid phase from the solid phase; exposing the liquid phase to electromagnetic radiation in of a wavelength that causes nitrosamines in the liquid phase to decompose; treating the liquid phase after exposure to the radiation to reduce the content of nitrate and/or nitrite ions therein; and combining the treated liquid phase with the solid phase.

25. Tobacco material produced by a method according to any one of claims 1 to 24.

26. A tobacco product incorporating tobacco material produced by a method according to any one of claims 1 to 24.

27. A method of manufacturing a nicotine delivery product comprising preparing a material that contains nicotine and other substances, exposing the nicotine containing material to electromagnetic radiation of a wavelength that causes nitrosamines to decompose, treating the nicotine-containing material to reduce nitrosamine decomposition products therein, and incorporating the treated nicotine-containing material in the nicotine delivery product.

28. A method according to claim 25 wherein the nicotine containing material is exposed to electromagnetic radiation in accordance with the method as set forth in any one of claims 1 to 25.

29. A nicotine delivery product manufactured by a method according to claim 27 or claim 28.
